(19) United States
(12) Patent Application Publication
(10) Pub. No.: US 2026/0189625 A1
(43) Pub. Date: Jul. 2, 2026

(54) Internet-of-Things Connectivity Modules and Associated Systems and Methods for Pool and Spa Equipment

(71) Applicant: Hayward Industries, Inc., Charlotte, NC (US)

(72) Inventors: Troy Renken, Hendersonville, TN (US); Jason Davila, North Kingston, RI (US); Matthew J. Carter, Middletown, RI (US); Craig A. Horrocks, North Kingston, RI (US); Louis E. Pereira, Assonet, MA (US); Maxwell S. Dehaven, Warwick, RI (US); Joseph A. Gundel, Warwick, RI (US); James L. Higgins, North Kingstown, RI (US)

(73) Assignee: Hayward Industries, Inc., Charlotte, NC (US)

(21) Appl. No.: 19/549,649

(22) Filed: Feb. 25, 2026

Related U.S. Application Data
(63) Continuation of application No. PCT/US24/44591, filed on Aug. 30, 2024.
(60) Provisional application No. 63/535,518, filed on Aug. 30, 2023.

(51) Int. Cl. H04L 67/12; H04L 41/082; H04W 4/30; H04W 24/02

(52) U.S. Cl. CPC H04L 67/12; H04L 41/082; H04W 4/30; H04W 24/02

(57) ABSTRACT

Internet-of-Things (IoT) connectivity modules and associated systems and methods for pool and spa equipment are provided. The IoT connectivity module includes an input/output module configured for communication with a pool or spa device, a radio module having a first wireless transceiver configured for wireless communication with a user wireless device and a second wireless transceiver configured for wireless communication with a gateway device, and a processor in communication with and controlling the input/output module and the radio module. The radio module is configured to receive a control command formatted in a first format using at least one of the first wireless transceiver or the second wireless transceiver. The processor is configured to process the control command into a second format compatible with the pool or spa device, and the input/output module is configured to transmit the control command in the second format to the pool or spa device, the pool or spa device executing the control command to control operation of the pool or spa device. The input/output module is also configured to receive a status message from the pool or spa device formatted in a third format, the processor is configured to process the status message into a fourth format, and the radio module is configured to transmit the status message to the user device in the fourth format using at least one of the first wireless transceiver or the second wireless transceiver.

### RELATED APPLICATIONS

This application is a 35 U.S.C. 111(a) continuation of International Application No. PCT/US24/44591 filed Aug. 30, 2024, which claims the priority of U.S. Provisional Application Ser. No. 63/535,518 filed on Aug. 30, 2023, the entire disclosures of which are expressly incorporated herein by reference.

### BACKGROUND

### Field of the Invention

The present disclosure relates to pool and spa equipment. More particularly, the present disclosure relates to Internet-of-Things (IoT) connectivity modules and associated systems and methods for pool and spa equipment.

### Related Art

In the pool and spa industry, swimming pool equipment can be controlled by an electronic pool controller at an equipment pad. Power can supplied from the controller and electrical subpanel to the pool/spa equipment through an electrical conduit. Also, pool/spa equipment can be controlled by electrical circuit breakers in a subpanel at an equipment pad. Still further, some pool/spa controllers allow for remote control and monitoring of connected pool/spa devices over the Internet, a local area network, a wireless network, etc.

In the “Internet-of-Things” (IoT) era, it is becoming increasingly desirable for consumer products to be remotely monitored and controlled over the Internet, including pool and spa devices. However, provisioning IoT connectivity and functionality for pool and spa devices can be challenging, especially if there is a desire to provide a wide range of connection methodologies for pool and spa devices such as Bluetooth, WiFi, and other types of wireless network connection methodologies. Also, it is desirable for pool and spa devices to be able to connect to a wide variety of devices such as remote computer systems, cloud-based computing systems/platforms, and mobile devices such as smart phones, tablet computers, and other mobile devices. Accordingly, the systems and methods disclosed herein address the foregoing and other needs.

### SUMMARY

The present disclosure relates to Internet-of-Things (IoT) connectivity modules and associated systems and methods for pool and spa equipment. An IoT connectivity module for a pool or spa device is provided, and includes an input/output module configured for communication with a pool or spa device; a radio module having a first wireless transceiver configured for wireless communication with a user wireless device and a second wireless transceiver configured for wireless communication with a gateway device, and a processor in communication with and controlling the input/output module and the radio module. The radio module is configured to receive a control command formatted in a first format (e.g., Bluetooth Low Energy (BLE) packet format or a sub-gigahertz radio packet format) using at least one of the first wireless transceiver or the second wireless transceiver. The processor is configured to process the control command into a second format compatible with the pool or spa device, and the input/output module is configured to transmit the control command in the second format to the pool or spa device, the pool or spa device executing the control command to control operation of the pool or spa device. The first wireless transceiver could include a BLE transceiver and the second wireless transceiver could include a sub-gigahertz wireless network transceiver.

The input/output module is also configured to receive a status message from the pool or spa device formatted in a third format (e.g., in a pool/spa device status message format), the processor is configured to process the status message into a fourth format (e.g., into a BLE or sub-gigahertz responsive radio packet format), and the radio module is configured to transmit the status message to the user device in the fourth format using at least one of the first wireless transceiver or the second wireless transceiver. The IoT connectivity module could be positioned within a pool or spa device (e.g., as a printed circuit board component within the pool or spa device), and/or provided as a separate module that connects with the pool or spa device via suitable power and data connections (e.g., RS-485 serial data connection). The gateway device could communicate with a cloud platform over the Internet, and the IoT module can register the pool or spa device as an IoT-connected pool or spa device. Additionally, the cloud platform can maintain and update a database of IoT-connected pool or spa devices at a pool or spa equipment pad.

### BRIEF DESCRIPTION OF THE DRAWINGS

The foregoing features of the invention will be apparent from the following Detailed Description, taken in connection with the accompanying drawings, in which:

FIG. 1 is a diagram illustrating the overall system of the present disclosure, wherein Internet connectivity and control is provided for various pool and spa equipment via one or more Internet-of-Things (IoT) connectivity modules and an associated IoT gateway device;

FIG. 2 is a block diagram illustrating an IoT connectivity module in accordance with the present disclosure;

FIGS. 3-6 are electrical schematic diagrams illustrating the IoT connectivity module of FIG. 2 in greater detail;

FIG. 7 is a diagram illustrating steps carried out by the system of the present disclosure for adding users to the system;

FIG. 8 is a diagram illustrating steps carried out by the system of the present disclosure for connecting an IoT-connected pool or spa device to an IoT-connected pool/spa equipment pad;

FIG. 9 is a diagram illustrating steps carried out by the system of the present disclosure for connecting an IoT-connected gateway device;

FIG. 10 is a diagram illustrating steps carried out by the system of the present disclosure for adding an IoT-connected pool or spa device to one or more accounts;

FIG. 11 is a diagram illustrating steps carried out by the system of the present disclosure for communication through the IoT gateway device;

FIG. 12 is a diagram illustrating steps carried out by the system of the present disclosure for authenticating an IoT-connected pool or spa device via a Bluetooth Low-Energy (BLE) data connection;

FIG. 13 is a diagram illustrating steps carried out by the system of the present disclosure for upgrading firmware;

FIG. 14 is a diagram illustrating steps carried out by the system of the present disclosure for controlling operation of an IoT-connected pool or spa pump;

FIG. 15 is a diagram illustrating steps carried out by the system of the present disclosure for upgrading firmware of the IoT gateway device;

FIGS. 16A-16B are diagrams illustrating steps carried out by the system of the present disclosure for controlling an IoT-connected pool or spa pump and an IoT-connected heater;

FIG. 17 is a diagram illustrating IoT connectivity in accordance with the present disclosure between a mobile phone, an IoT gateway device, and an IoT-connected pump;

FIG. 18 is a diagram illustrating IoT connectivity in accordance with the present disclosure between a mobile phone and an IoT-connected pump;

FIG. 19 is a block diagram illustrating additional features of the IoT connectivity module of the present disclosure, wherein high-voltage isolation is provided; and

FIGS. 20-21 are schematic diagrams illustrating the high-voltage isolation circuitry of FIG. 19 in greater detail.

### DETAILED DESCRIPTION

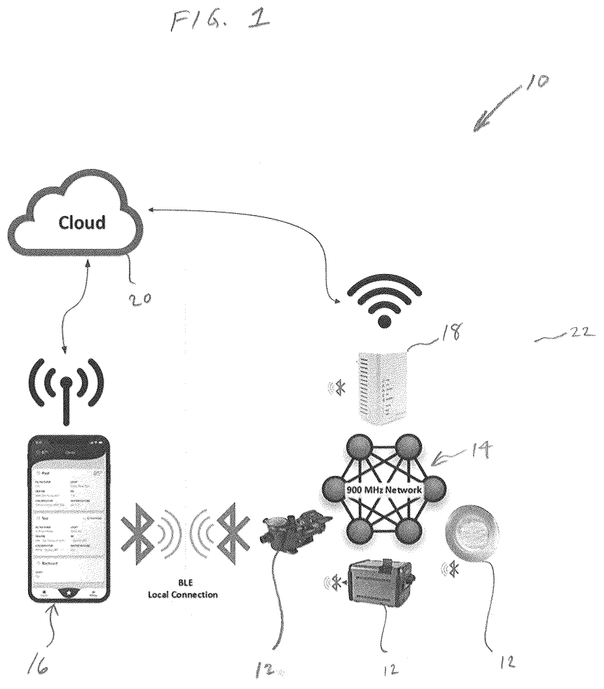

The present disclosure relates to Internet-of-Things (IoT) connectivity modules and associated systems and methods for pool and spa equipment, as described in detail below in connection with FIGS. 1-21.

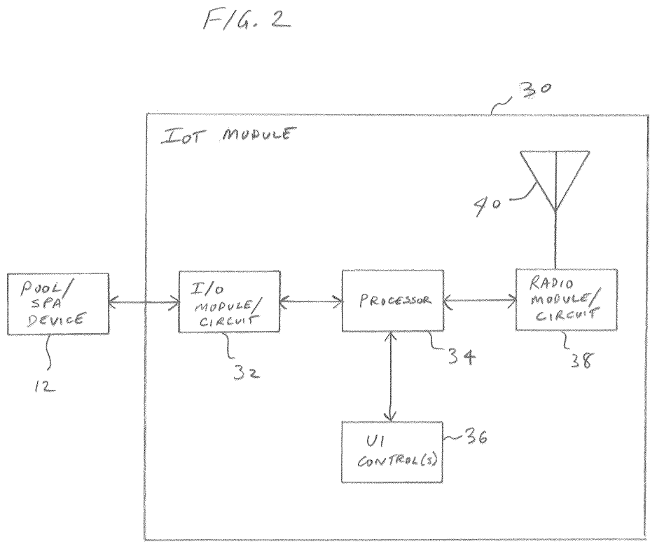

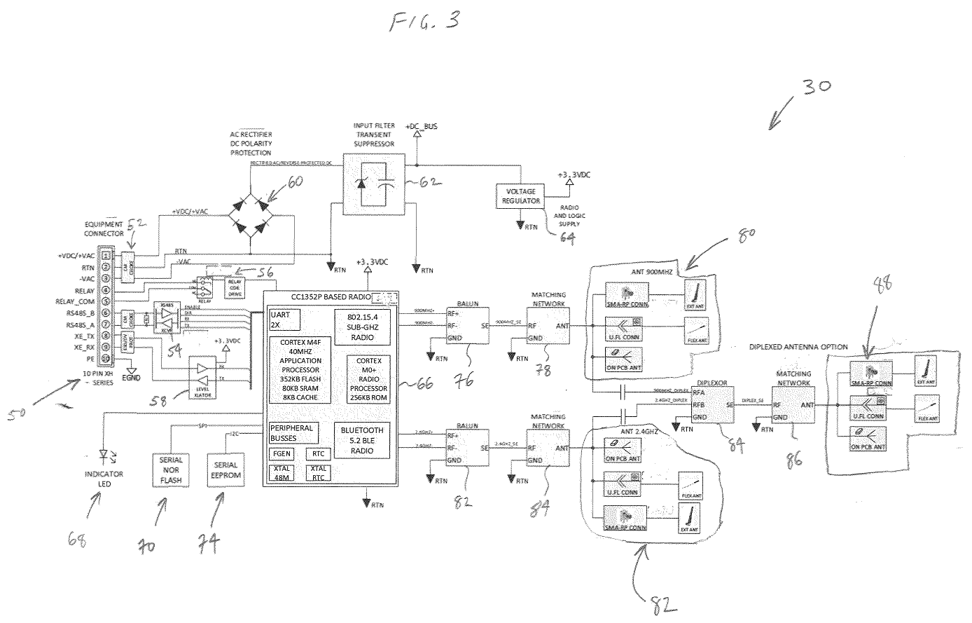

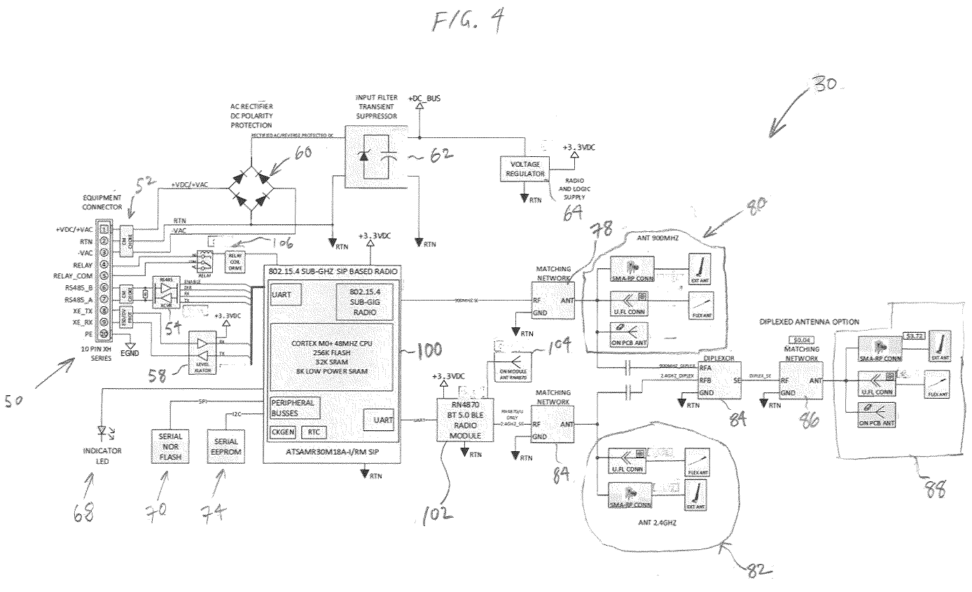

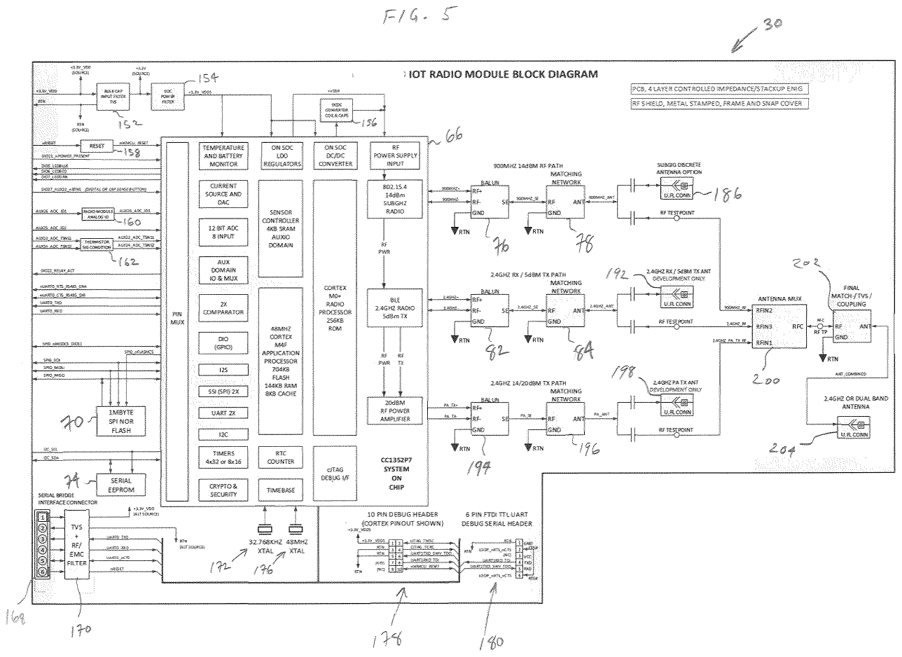

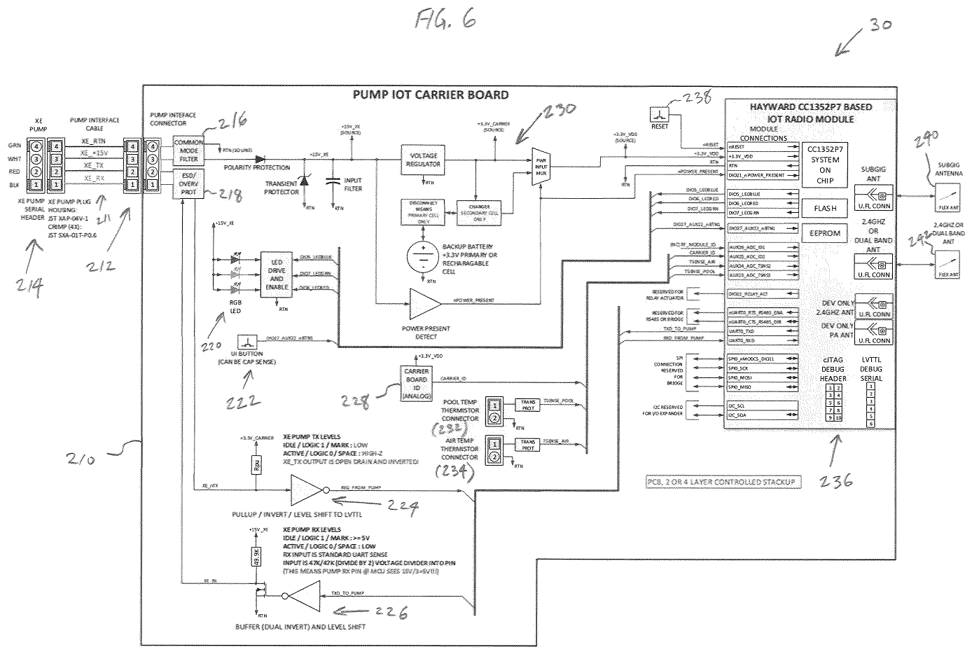

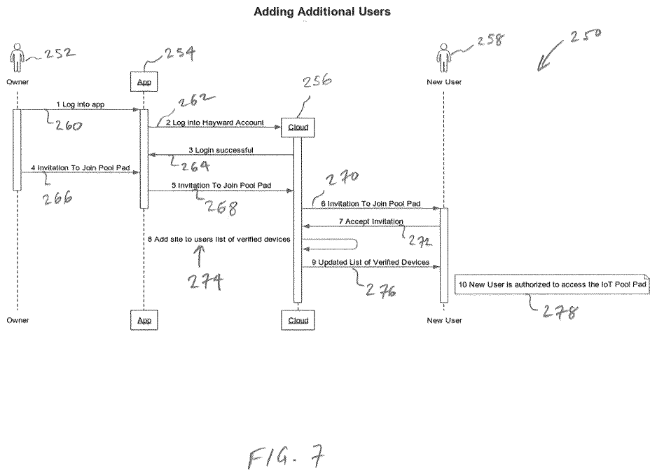

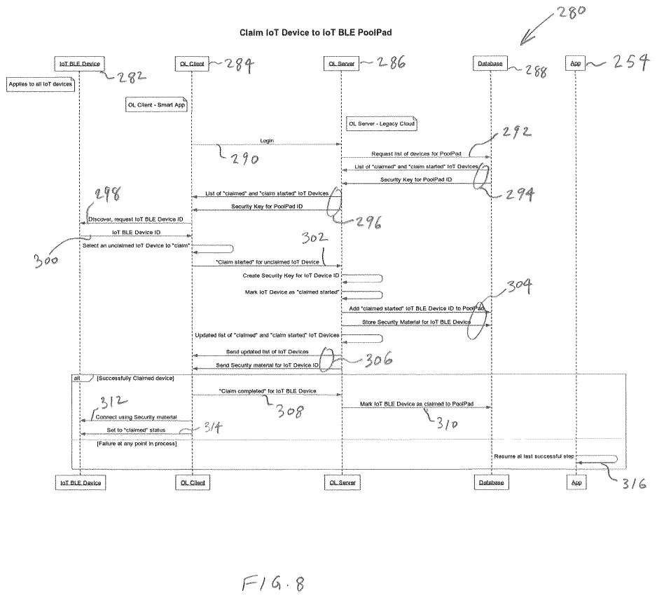

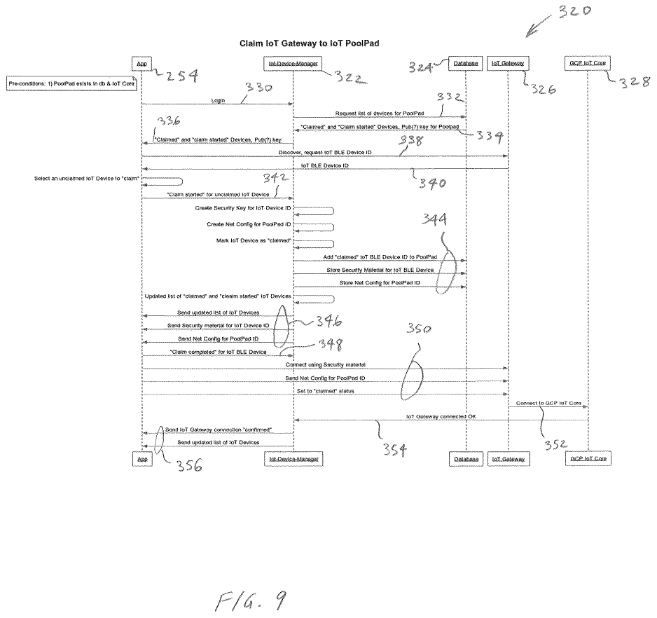

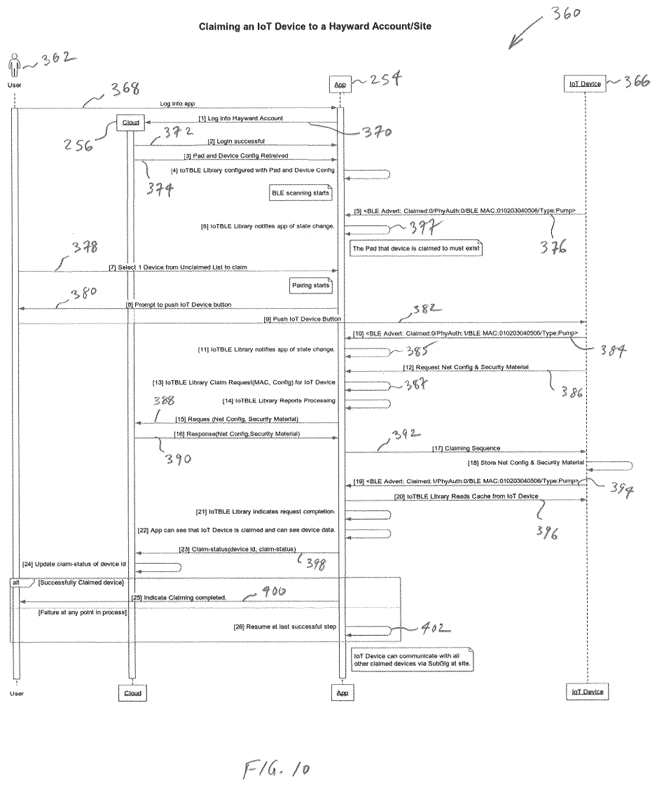

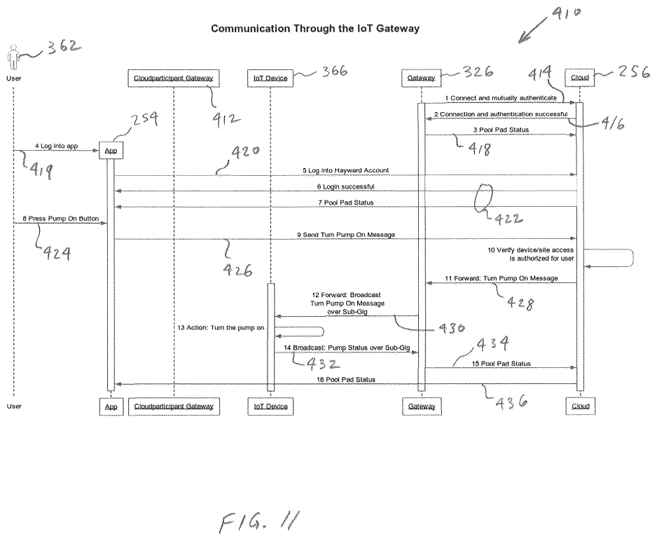

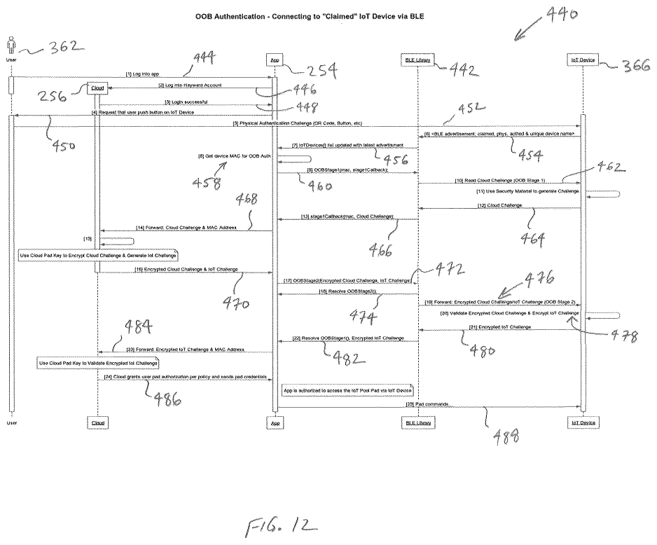

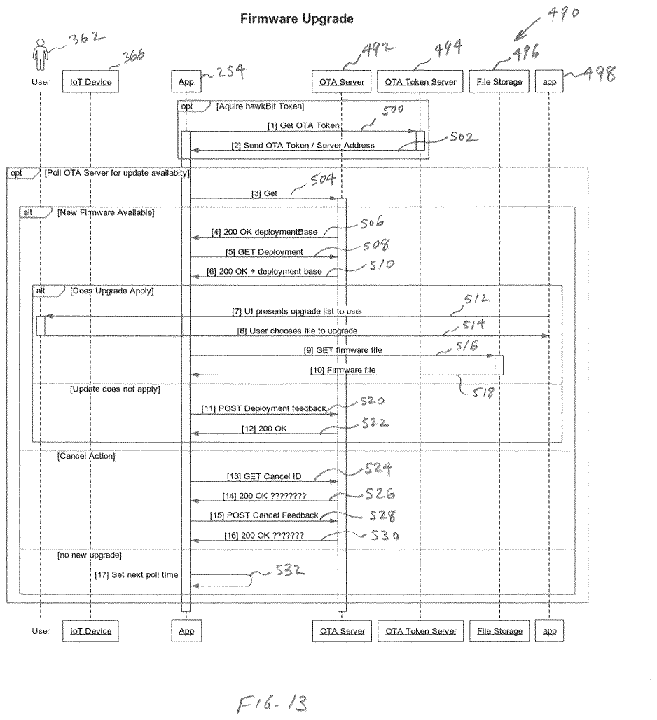

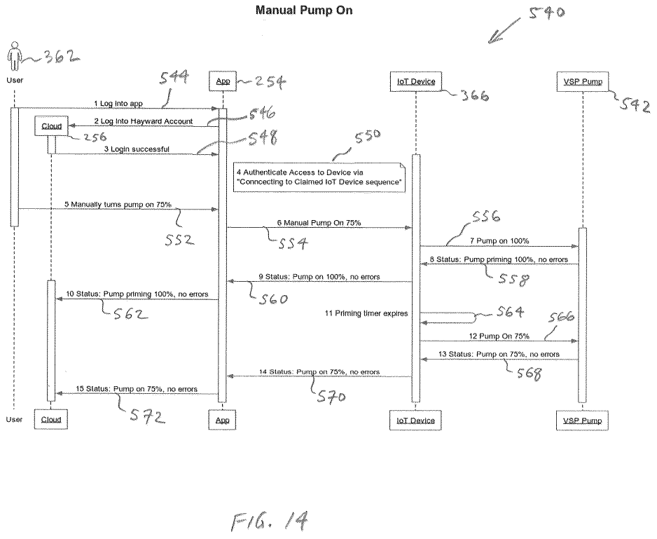

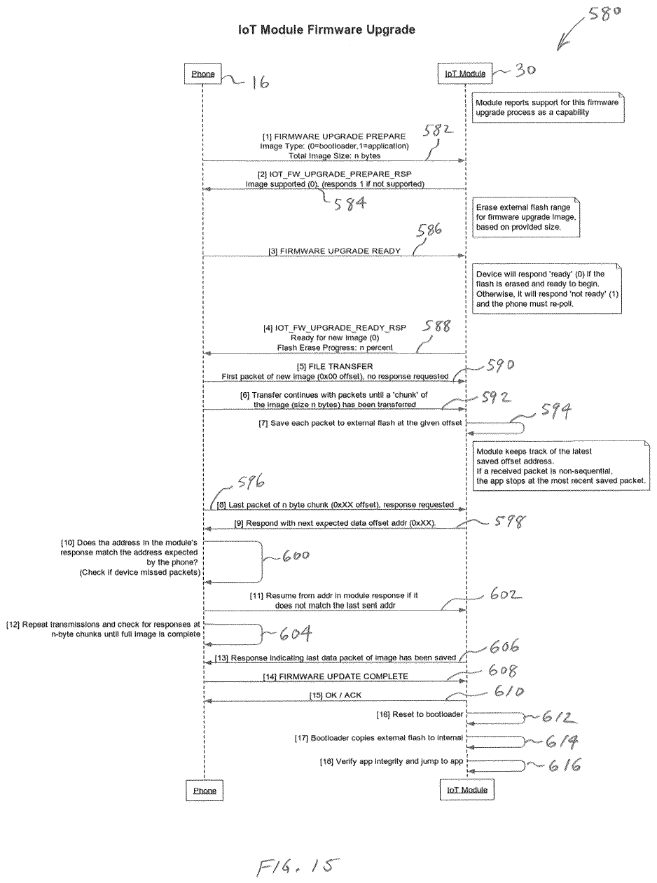

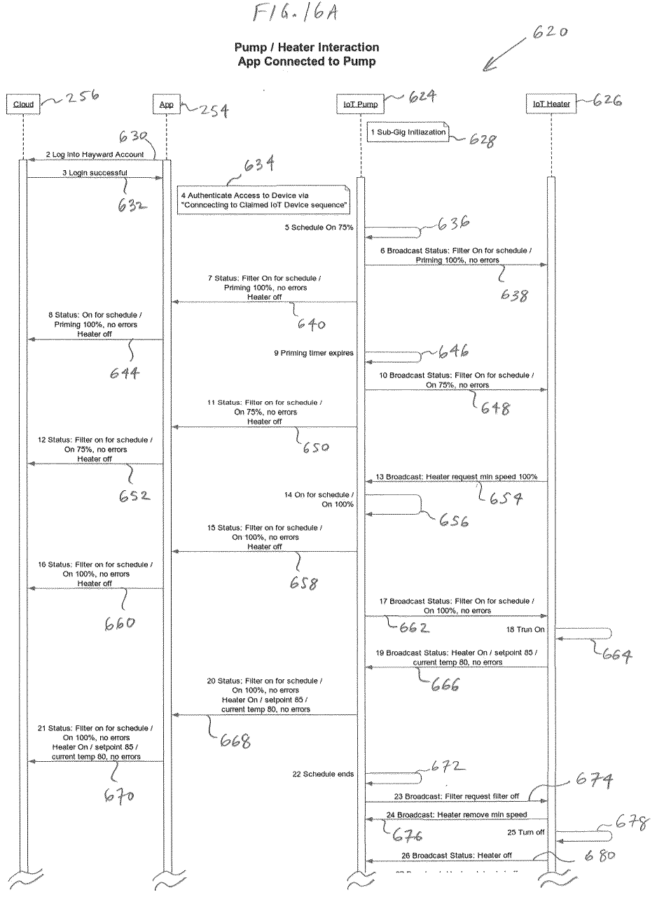

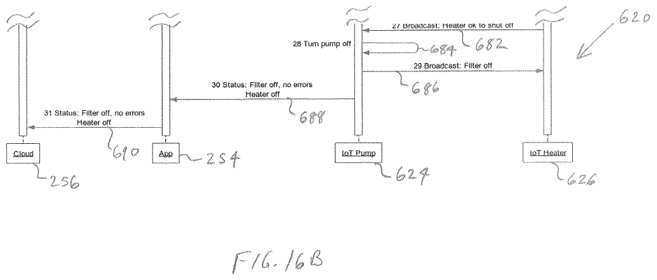

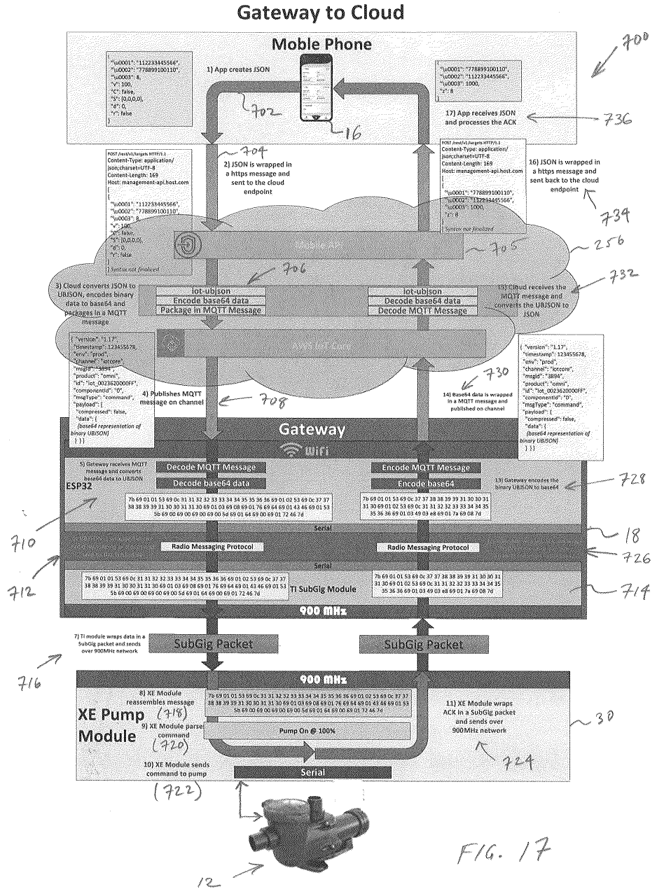

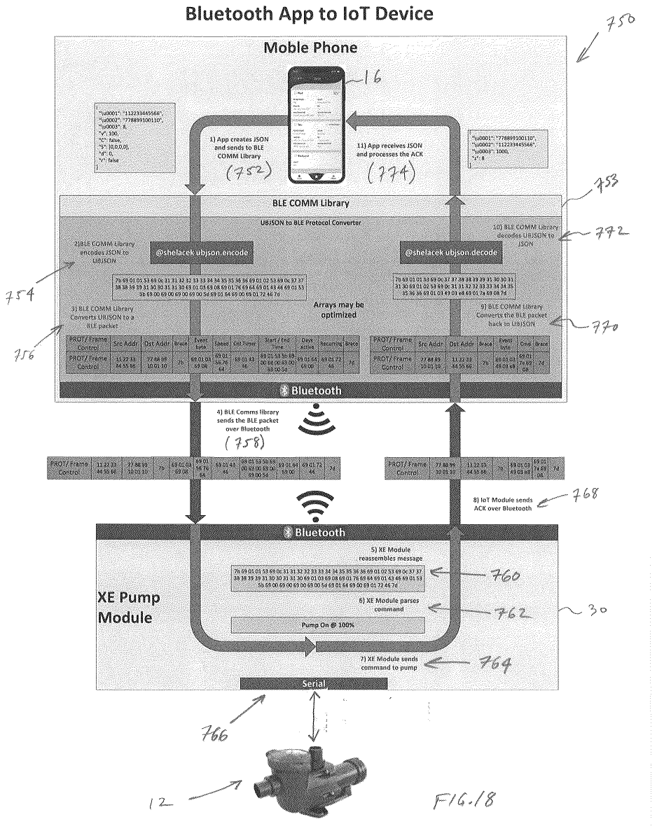

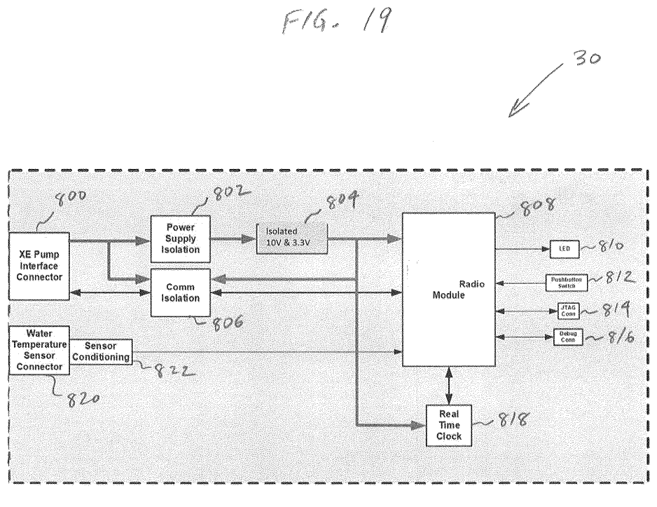

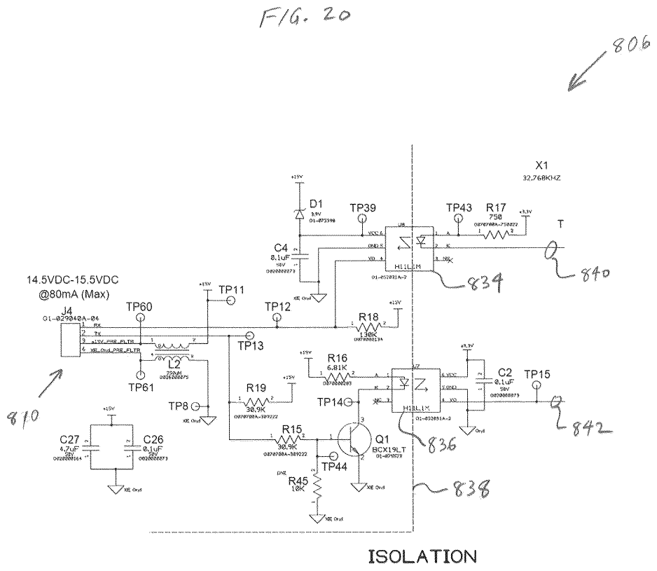

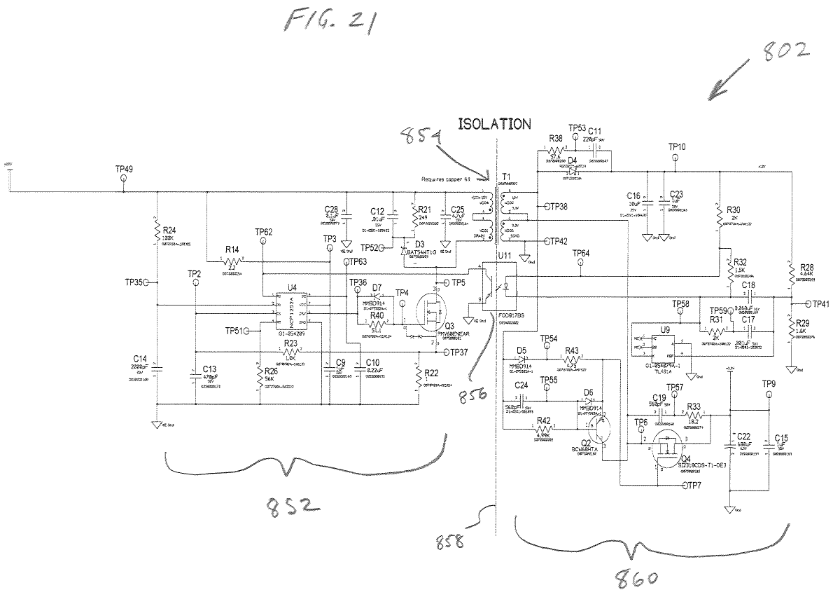

FIG. 1 is a diagram illustrating the overall system of the present disclosure, indicated generally at 10, wherein Internet connectivity and control is provided for various pool and spa equipment 12 via one or more Internet-of-Things (IoT) connectivity modules (described in detail below in connection with FIGS. 2-6) and an associated IoT gateway device 18. The pool and spa equipment 12 includes, but is not limited to, pumps (including single-speed, multiple-speed, and/or variable-speed), heaters, lights, sanitization devices (e.g., chlorinators, chemical dispensers, etc.), cleaners, filters, valve controllers, pool/spa system controllers, sensors, or any other suitable device at a pool or spa equipment pad 22. A user's smart cellular phone 16 can communicate with the one or more pool or spa devices 12 over the Internet (cloud) 20 through the IoT gateway device 18, or directly to each pool or spa device 12 via a direct network connection (e.g., Bluetooth, Bluetooth Low Energy (BLE), WiFi, or other wired or wireless connection) between the phone 16 and the one or more devices 12.

Additionally, the devices 12 can communicate with each other using the IoT connectivity modules described herein, forming a wireless communications network 14 at the equipment pad. The network 14 could be a 900 MHz wireless (e.g., sub-gigahertz) communications network or other suitable communications network. In such circumstances, each of the devices 12 communicates wirelessly with the gateway 18 using a 900 MHz wireless communications link or other suitable communications link. The gateway 18 communicates with the Internet (cloud) 12, permitting communications between the devices 12 and the phone 16 and/or to one or more remote computing devices (e.g., servers, cloud servers, cloud computing platforms, etc.). It is noted that the cloud 12 need not be limited to the Internet, and could also include a local area network, a wide area network, a personal area network, a home wireless network, or other suitable type of network. Additioanlly, it is noted that the phone 16 could also communicate with the gateway 18 and/or the IoT connectivity modules of the pool or spa devices 12 using a cellular communications data connection (e.g., LTE, 4G, or 5G wireless cellular data connection), Bluetooth, Zigbee, WiMax, mesh network, WiFi, near-field communication (NFC), or other suitable data communications connection.

FIG. 2 is a block diagram illustrating an IoT connectivity module 30 in accordance with the present disclosure. As noted in connection with FIG. 1, each of the pool or spa devices 12 could include an IoT connectivity module 30 which allows for communication with the phone 16 (either directly via a direct wireless (e.g., Bluetooth Low Energy) connection, or indirectly via the gateway 18 (900 MHz wireless connection) and the Internet (cloud) 20), as well as with other pool/spa devices 12 via the wireless network 900 and with one or more remote devices via the gateway 18 and the Internet (cloud) 20. The module 30 includes an input/output (I/O) module or circuit 32 that permits communication with the pool or spa device 12 using a suitable communications connection/protocol, such as a wired RS-485 connection between the pool or spa device 12 and the I/O module 32 or other (e.g., wired or wireless) communications connection/protocol. Additionally, the IoT module 30 includes a processor 34 (e.g., microprocessor, microcontroller, or other suitable programmed device) for controlling operation of the module 30 and provisioning of IoT communications for the pool/spa device 12, one or more user interface controls 36 for allowing a user to interact with and control the module 30 (e.g., one or more buttons, indicators, lights, LEDs, display panels, touch screens, knobs, switches, etc.), a radio module/circuit 38 which establishes wireless communications with one or more of the smart phone 16, one or more other pool/spa devices 12, or the gateway 18), and an antenna system 40.

FIGS. 3-6 are electrical schematic diagrams illustrating the IoT connectivity module 30 of FIG. 2 in greater detail. As shown in FIG. 3, the module 30 includes an equipment connector 50 for electrically connecting the module 30 to a pool or a spa device (e.g., to one or more of the pool or spa devices 12 of FIG. 1). The connector 50 provides both power as well as data connectivity (e.g., serial RS-485) such that the module 30 can retrieve data from, and send data to, the connected pool or spa device via the connector 50. A choke 52 is connected to the power pins/connections of the connector 50, and filters electromagnetic interference. An RS-485 transceiver 54 provides a data connection through the connector 50 between the module 30 and the pool or spa device 12 (e.g., a serial RS-485 data connection). Relay communication/control is also possible through the connector 50 via a relay and associated relay coil driver 56 (e.g., the module 30 can control operation of a pool or spa device through control signals controlled by a relay). A level translator 58 controls data transmission and reception signal levels in connection with signals transmitted to the pool or spa device from the module 30 and received from the pool or spa device by the module 30. A bridge rectifier 60 provides full-wave rectified direct current (DC) power for the components of the module 30, from alternating current (AC) power received from the pool or spa device through the connector 50. An input filter transient suppressor circuit 62 clamps power transients and filters noise from power being supplied to the module 30. A voltage regulator 64 regulates DC voltage levels being provided to the components of the module 30.

The module 30 includes a CC1352P-based radio module 66 having a serial (UART 2X) transceiver, an application processor (e.g, a Cortex M4F 40 MHz application processor having 352 kB of flash memory, 80 kB of static random access memory (SRAM), and a8 kB cache memory), one or more peripheral buses, various clock/oscillator circuits, a sub-gigahertz (sub-GHz) radio module, a radio processor/controller (e.g., a Cortex M0+ radio processor having 256 kB read-only memory (ROM)), and a Bluetooth radio module (e.g., a Bluetooth 5.2 BLE radio module). The application processor of the radio module 66 is programmed to perform one or more of the processes described in further detail below in connection with FIGS. 7-16B, including establishing a wireless IoT connection for remote monitoring and control of a pool or spa device connected to the module 30. An indicator light-emitting diode (LED) 68 is provided and can be illuminated to indicate operation of the module 30 and/or the presence of an IoT connection established by the module 30 for the connected pool or spa device. A serial NOR flash memory 70 and a serial electrically-eraseable, programmable memory (EEPROM) 74 could be provided and in communication with the module 66, such that one or more computer-readable instructions can be stored on such memories and executed by the application processor and/or radio processor of the radio module 66.

The module 66 allows for wireless communication with a sub-gigahertz (e.g., 900 MHz) wireless communications network, such as the network 14 of FIG. 1, permitting the connected pool or spa device to communicate with such network and/or one or more devices forming part of such network (e.g., one or more of the pool/spa devices 12 of FIG. 1 and/or the bridge 18). In this regard, 900 MHz radiofrequency (RF) signals are transmitted from the module 66 to balun 76, and then through a matching network 78 and a 900 MHz antenna subsystem 80, for transmission and reception of data on the 900 MHz network (e.g., the network 14 of FIG. 1). As depicted, the antenna subsystem 80 could include one or more RF connectors and antennas (e.g., external antennas, flexible antennas, etc.), and/or a printed circuit board (PCB) antenna.

The module 66 also allows for wireless communication using a Bluetooth Low Energy (BLE) wireless connection, such as between the module 30 and the user's smart phone 16 of FIG. 1. In this regard, 2.4 GHz Bluetooth signals are transmitted from the module 66 to balun 82, and then through a matching network 84 and a 2.4 GHz antenna subsystem 82, for transmission and reception of Bluetooth data (e.g., to and from the smart phone 16 of FIG. 1). As depicted, the antenna subsystem 82 could include one or more RF connectors and antennas (e.g., external antennas, flexible antennas, etc.), and/or a printed circuit board (PCB) antenna.

Optionally, the module 30 could include a duplexed antenna option, such that the sub-gigahertz (900 MHz) and Bluetooth wireless signals are transmitted and received using a single diplexed antenna subsystem 88. In such circumstances, RF outputs from the matching networks 78, 84 are fed to a diplexor 84, through a matching network 86, and then to the diplexed antenna subsystem 88. As with the antenna subsystems 80, 82, the subsystem 88 could include one or more RF connectors and antennas (e.g., external antennas, flexible antennas, etc.), and/or a printed circuit board (PCB) antenna.

As shown in FIG. 4, the radio module 66 of FIG. 3 could be substituted with a Session Initiation Protocol (SIP)-based radio module 100. A number of the components discussed above in connection with FIG. 3 are also utilized with the radio module 100, including the connector 50, choke 52, RS485 transceiver 54, level translator 58, bridge rectifier 60, input transient filter suppressor 62, voltage regulator 64, indicator LED 68, serial NOR flash memory 70, serial EEPROM memory 74, the matching networks 78 and 84, the antenna subsystems 80 and 82, the diplexor 84, the matching network 86, and the diplex antenna subsystem 88, and perform the same functions discussed above in connection with FIG. 3. The radio module 100 includes UARTs, peripheral busses, real-time clock, and a central processor (e.g., a Cortex M0+ 48 MHz CPU with 256k flash memory, 32k SRAM, and 8k low-power SRAM), as well as a sub-gigahertz (e.g., 900 MHz) radio submodule. An RN4870 Bluetooth Low Energy transceiver radio module 102 is in communication with one of the UARTs of the radio module 100 and is external thereto, and optionally includes an on-module antenna 104. 2.4 GHz RF output of the module 102 is fed to the matching network 84.

FIG. 5 is a block diagram further illustrating implementation of the IoT connectivity module 30 in greater detail. As can be seen, the module 30 includes a number of the components discussed above in connection with FIG. 3, including the radio module 66, the serial NOR flash memory 70, the serial EEPROM memory 74, the baluns 76, 82, and the matching networks 78, 84. Also shown in FIG. 5 are a bulk capacitor input filter 152 (for reducing TV interference), a system-on-chip (SOC) power filter 154, DC-to-DC converter coil and capacitors 156, a reset signal/switch 158 (for resetting operation of the module 66), a radio module analog identifier signal/memory 160, a thermistor signal conditioner module 162, a serial bridge interface connector 168, a TV/RF/EMC filter 170, a 32.768 kHz clock crystal 172, a 48 MHz clock crystal 176, a 10-pin debugging header 178, a 6-pin serial debugging header 180, a sub-gigahertz antenna option connector 186, a 2.4 GHz receiver/transmit antenna connector 192, a 2.4 GHz balun 194, a third matching network 196, a 2.4 GHz antenna connector 198, an antenna multiplexor 200, a final matching/TVS/coupling module 202, and a 2.4 GHz or dual band antenna connector 204. As shown, the radio module 66 includes an on-chip RF power amplifier, the outputs of which are fed to the balun 194 and the matching network 196. Advantageously, the antenna multiplexor 200 allows for transmission and reception of sub-gigahertz (900 MHz) signals, lower-powered 2.4 GHz (e.g., Bluetooth) signals, and higher-powered 2.4 GHz (e.g., Bluetooth) signals using a single antenna.

FIG. 6 is a diagram illustrating the IoT connectivity module 30, configured for installation as a “carrier” board 210 on a pump (e.g., as a dedicated circuit board installed within a housing of a pump, or forming part of a larger circuit board of the pump). A pump interface cable 211 connects the carrier board 210 to a pump via a pump connector 214 at one end of the cable 211 and a carrier board connector 212 provided on an opposite end of the cable 211. The cable provides both power (e.g., +15 volts) and data (e.g., serial RS-485 data) to the carrier board 210 from the pump via the connectors 212, 214. The board includes a common mode filter 216 for filtering power supplied by the pump, an electrostatic discharge and overload protection module 218 for protecting circuitry of the board 210, a plurality of status LEDs 220 showing various operational states of the board (including red, green, and blue LEDs), a user interface button 222 for allowing the user to control one or more operational parameters of the board 210, a transmit data inverter circuit (which inverts data transmitted to the board 210 from the pump), a receive data inverter circuit (which inverts data transmitted to the pump from the board 210), a carrier board analog identifier circuit/module 228, power supply circuitry 230 (which could include, but is not limited to, polarity protection and transient protection diodes, filter capacitors, a voltage regulator, power transient detection circuitry, a backup battery and associated charging circuitry, and a power input multiplexer.

The board 210 also includes a connector 232 for connecting a pool temperature thermistor and a connector 234 for connecting an ambient air temperature thermistor, for measuring pool water temperature and ambient air temperatures. A radio module 236, identical to the radio module 66 discussed above in connection with FIG. 3, is also provided, as well as a sub-gigahertz (e.g., 900 MHz) antenna and a 2.4 GHz (e.g., Bluetooth) or dual-band antenna 242.

FIG. 7 is a diagram illustrating steps carried out by the system of the present disclosure, indicated generally at 250, for adding users to the system. In step 260, the user 252 (e.g., a pool/spa equipment owner) logs into a software application 254 executed by the system, such as a web-based software application or application executing on the user's smart phone 16 of FIG. 1, which allows for remote monitoring, control, and other IoT-related functionality for the one or more pool/spa devices 12 of FIG. 1 using the software application 254. In step 262, the software application 254 requests that the user logs into his/her account associated with the one or more pool/spa devices 12, whereupon the user's login information (e.g., username and password, or other form of authentication) is transmitted from the software application 254 to a remote server or cloud-based platform 236 (referred to either individually or collectively herein as the “cloud” 256). In step 264, when the cloud 256 successfully logs in or authenticates the user, a login successful message is sent to the application 254. Then, in step 266, the user 252 issues an invitation to join a pool or spa pad through the application 254, which is then transmitted in step 268 from the application 254 to the cloud 256. In step 270, the invitation is transmitted to from the cloud 256 to a new user 258 (e.g., a family member who resides at the same residence as the user 252, a pool/spa servicer, a facility manager, a landlord, etc.). In step 272, the new user 258 accepts the invitation, and the acceptance is sent to the cloud 256. Then, in step 274, the cloud 256 adds the pool/spa site (pad) to a list of verified devices associated with the pool/spa site/pad. In step 276, the cloud 256 generates and transmits an updated list of verified devices to the new user 258, whereupon in step 278 the new user is authorized to access the pool/spa site (pad) (e.g., granted the ability to remotely monitor and/or control one or more of the pool/spa devices 12 of FIG. 1).

FIG. 8 is a diagram illustrating steps carried out by the system of the present disclosure, indicated generally at 280, for connecting an IoT-connected pool or spa device to an IoT-connected pool/spa equipment pad. It is noted that the terms “claim” or “claiming” are shown in FIG. 8 and other figures, and it is to be understood that such terms refer to processes for identifying and connecting an IoT-connectable pool or spa device (or gateway) as disclosed herein. In step 290, a user operating an online (“OL”) client device 284 (e.g., the user's smart phone 16 of FIG. 1) and a smart application executing thereon (such as the application 254 discussed in connection with FIG. 7) logs into an OL server 286, which could be a server forming part of a cloud service (such as the cloud 256 discussed in connection with FIG. 7). In step 292, the OL server 286 transmits a request for a list of pool/spa devices associated with the user's pool pad to a database 288. Next, in step 294, the database 288 returns to the OL 286 server a list of “claimed” (IoT-connected) and “claim started” (devices for which the IoT connection process has begun) devices associated with the user's pool pad, along with a security key for the pool pad identifier. In step 296, the OL server 286 transmits the list of claimed and claim started devices to the OL client device 284, along with the security key for the pool pad identifier. In step 298, the OL client 284 transmits a discovery request for an IoT BLE (Bluetooth Low Energy) device 282 (e.g., for one or more of the pool/spa devices 12 capable of communicating using BLE). In step 300, the IoT BLE device 282 responds to the discovery request with an IoT BLE device identifier, whereupon the OL client 284 selects an unclaimed IoT device to claim (i.e., one or more of the responding pool/spa devices 12 is selected by the OL client 284). In step 302, the OL client 284 transmits a “claim started” message for the selected (but not yet claimed) IoT device to the OL server 286. Thereupon, the OL server 286 creates a security key for the IoT BLE device identifier, and also marks the selected IoT device as a “claim started” device.

In step 304, the OL server 286 transmits a message to the database 288 requesting that the database 288 add the IoT BLE device identifier to the pool pad, and also transmits security material for the selected IoT device to the database 288, which then adds the device identifier to the pool pad and stores the security material. Thereafter, the OL server 286 creates an updated list of claimed and claim started IoT devices. In step 306, the OL server 286 sends an updated list of IoT device to the OL client device 284 as well as security material for the IoT device identifier. At this point, the selected IoT device is successfully claimed (IoT connected) by the system. In step 308, the OL client 384 sends a “claim completed” message for the selected IoT device to the OL server 286. Then, in step 310, the OL server 286 sends a message to the database 288 to mark the selected IoT device as claimed to the poolpad, whereupon the database 288 so marks the selected IoT device. In step 312, the OL client device 284 connects to the IoT BLE device 282 using the security material, and in step 314, the OL client 284 transmits a message to the Iot BLE device indicating that the status of the device 282 has been set to claimed. In the event that a connection (claiming) error occurs, in step 316, the application 254 can resume operation at the last successful step.

FIG. 9 is a diagram illustrating steps carried out by the system of the present disclosure, indicated generally at 320, for connecting an IoT-connected gateway device (such as the gateway 14 of FIG. 1). In step 330, the software application 254 logs into an IoT device manager 322, which could be a software application or process executing in the OL server 286 or elsewhere. In step 332, the device manager 322 request a list of devices for a particular pool pad from the database 324. In step 334, the database 324 returns a list of claimed and claim started devices, as well as a key (e.g., public encryption key) for the pool pad, to the device manager 322. In step 336, the device manager 322 returns the list of claimed and claim started devices as well as the key to the application 254. In step 338, the application 254 transmits a request for an IoT BLE device identifier to the IoT gateway device 326 (which could correspond to the gateway 14 of FIG. 1). In step 340, the IoT gateway device 326 returns an IoT BLE device identifier to the application 254, whereupon the application 254 selects an unclaimed IoT device to be claimed. Then, in step 342, the application 254 transmits a claim started notification for the unclaimed IoT device to the device manager 322. In response, the device manager 322 creates a security key for the IoT device identifier, creates a network configuration for the pool pad identifier, and marks the IoT device as claimed. In step 344, the device manager 322 adds the claimed IoT BLE device to the pool pad list and stores same in the database 324. Also, the device manager 322 stores security material for the IoT BLE device in the database 324, and stores the network configuration for the pool pad identifier in the database 324. Thereafter, the device manager 322 updates the list of claimed and claim started IoT devices.

In step 346, the device manager 322 sends the updated list of IoT devices to the application 254, along with the security material for the IoT device identifier and the network configuration for the pool pad identifier. In step 348, the application 254 sends a claim completed message for the IoT BLE device to the device manager. Then, in step 350, the application 254 connects to the gateway device 326 using the security material, sends the network configuration for the pool pad identifier to the gateway device 326, and sets the status for the IoT BLE device to claimed. In step 352, the gateway device 326 connects to a Google Cloud Platform (GCP) IoT core 328 or other suitable type of cloud platform, and in step 354, the GCP IoT core 328 sends a message to the device manager 322 indicating the IoT gateway 326 is properly connected. Finally, in step 356, the device manager 322 sends an IoT gateway connection confirmed message to the application 254, and also sends an updated list of IoT devices to the application 254.

FIG. 10 is a diagram illustrating steps carried out by the system of the present disclosure, indicated generally at 360, for adding (“claiming”) an IoT-connected pool or spa device to one or more accounts. In step 368, the user 362 logs into the software application 254. In step 370, the application 254 connects to (logs into) the cloud 256. In step 372, the cloud 256 transmits a “login successful” message to the software application 254, and also retrieves and transmits pool pad and device configuration information to the application 254, whereupon the application 254 (including an IoT BLE library) are configured with the pad and device configuration information and BLE scanning is initiated. In step 376, an IoT device 366 (e.g., one or more of the pool or spa devices 12 of FIG. 1) responds to the BLE scan by transmitting a BLE advertisement (message) that includes information about the IoT device 366, such as a hardware address (e.g., media access control (MAC)) address and a device type identifier (e.g., pump)). In response, in step 377, the IoT BLE library notifies the application 254 of the state change (i.e., that the device 366 exists and is ready to be added (claimed). Next, in step 378, the user 362 selects the device 366 from a list of unclaimed devices displayed to the user, and the pairing process starts. In step 380, the application 354 prompts the user 362 to push an IoT device button (e.g., one of the UI controls 36 of FIG. 1) on the device 366. In response, in step 382, the user pushes the IoT device button on the IoT device 366. Then, in step 384, the IoT device 384 transmits an advertisement (message), which could include the hardware (MAC) address of the device 366 and an a device type identifier. In step 385, the IoT BLE library notifies the application 254 of a state change. Then, in step 386, the IoT device 366 requests a network configuration and security material (information).

In step 387, the IoT BLE library issues a claim request for the IoT device 366 and the IoT BLE library reports processing of the request. In step 388, the application 254 requests a network configuration and security material (information) from the cloud 256. In step 390, the cloud 256 responds and transmits the network configuration and security material to the application 254. In step 392, the claiming sequence is initiated, wherein the application 254 transmits the network configuration and security material to the IoT device 366 and the IoT device 366 stores the network configuration and security material information. Thereafter, in step 394, the IoT device transmits an advertisement (message) to the application 254 indicating that the IoT device 366 is officially claimed, and also including the hardware (MAC) address and the device type identifier. In step 396, the IoT BLE library of the application 254 reads a memory (cache memory) of the IoT device 366. Thereafter, the IoT BLE library of the application 254 indicates a request completion, and the application 254 can see that the IoT device 366 is claimed as well as the device data. In step 398, the application 254 transmits claim status information to the cloud 256, including device identifier information and claim status, whereupon the cloud 256 updates the claim status of the device identifier. In step 400, a message could be sent from the application 254 to the user 362, indicating that the claiming process is complete and that the IoT device 366 has been successfully claimed. The IoT device 366 can then communicate with all other claimed devices (e.g., one or more of the devices 12 of FIG. 1) using a sub-gigahertz network (e.g., the network 14 of FIG. 1). Additionally, in the event of an error, step 402 can be carried out, wherein the application 254 resumes operation at the last successful step prior to the error.

FIG. 11 is a diagram illustrating steps carried out by the system of the present disclosure, indicated generally at 410, for communication through the IoT gateway device. In step 414, the gateway device 326 (e.g., the gateway 14 of FIG. 1) connects to and is mutually authenticated with the cloud 256. Next, in step 416, once the devices are authenticated, the cloud 256 communicates a message to the gateway device 326 and the cloud 256 are connected and that authentication was successful. In step 418, the gateway device 326 transmits pool pad status information to the cloud 256. In step 419, a user 362 logs into the software application 254. Then, in step 420, the application 254 logs into an account on the cloud 256. Thereafter, in step 422, the cloud 256 transmits a message that the login was successful as well as pool pad status information to the application 254. In step 424, the user 424 presses a button to initiate an operation (e.g., a “pump on” button on one of the pool/spa devices 12 of FIG. 1, or a graphical user interface (GUI) button displayed on a smart phone (e.g., the smart phone 16 of FIG. 1). In step 426, the application 254 transmits an operation message (e.g., a message requesting that a pump be turned on) to the cloud 256, which then verifies that the device requesting the operation (e.g., the smart phone 16 of FIG. 1) and/or the location (site) of the device is authorized for the user. Then, in step 428, the cloud 256 transmits an operation message (e.g., a message to turn a pump on) to the gateway device 326. In step 430, the gateway 326 forwards a broadcast message to the IoT device 366 (e.g., one or more of the devices 12 of FIG. 1) to perform the requested operation (e.g., turn on) over the sub-gigahertz wireless network (e.g., over the network 14 of FIG. 1). In response, the IoT device 366 performs the requested operation (e.g., turns on). In step 432, the IoT device 366 broadcasts device status information (e.g., pump status information if the IoT device 366 is a pump) to the gateway 326 over the sub-gigahertz network (e.g., over the network 14 of FIG. 1). In step 434, the pool pad status information is transmitted from the gateway 326 to the cloud 256. Finally, in step 436, the cloud sends the pool pad status information to the software application 254 so that the application is updated with current information about the status of the pool pad (e.g., the current status of the devices 12 of FIG. 1).

FIG. 12 is a diagram illustrating steps carried out by the system of the present disclosure, indicated generally at 440, for out-of-band (“OOB”) authentication of an IoT-connected pool or spa device via a Bluetooth Low-Energy (BLE) data connection. In step 444, the user 362 logs into the software application 254. In step 446, the software application 254 then logs into an account on the cloud 256 associated with the user 362. Next, in step 448, the application 448 requests that the user 362 actuate a control (e.g., push a button) on the IoT device 366 (one or more of the devices 12 of FIG. 1) by, e.g., pushing one of the UI controls 36 of FIG. 2. In step 452, the user actuates the control, which causes the system to issue a physical authentication challenge to the user (e.g., requiring the user to scan a quick-response (QR) code or actuate a physical control/button). Once the authentication challenge is completed by the user, step 454 occurs, wherein the IoT device 366 transmits a BLE advertisement to a BLE library 442 that includes an identifier of the IoT device 366 as well as a unique device name for the IoT device 366. In step 456, the BLE library 442 transmits to the application 254 an updated IoT device list that includes the latest advertisement (e.g., the BLE advertisement sent from the IoT device 366 in step 454). In step 458, the application 254 obtains the MAC address of the IoT device 336 for OOB authentication. In step 460, the application 254 begins OOB authentication stage one, wherein a MAC address and a callback message are sent to the BLE library 442. In step 462, the BLE library 442 transmits a cloud challenge request to the IoT device 366. In response, the IoT device 366 uses security material (e.g., one or more security identifiers associated with the IoT device 366) to generate the cloud challenge, and in step 464, the cloud challenge is transmitted from the IoT device 366 to the BLE library 442.

In step 466, the BLE library 442 transmits the cloud challenge to the application 254, and in step 468, the application 254 forwards both the cloud challenge and the MAC address to the cloud 256, which encrypts the cloud challenge using an encryption key and generates a second (IoT) challenge. In step 470, the encrypted cloud challenge and the IoT challenge are transmitted to the application 254. In step 472, the application 254 transmits the encrypted cloud challenge and the IoT challenge to the BLE library 442. Then, in step 474, the BLE library 442 transmits a message to the application 474 indicating that a second OOB stage (stage two) is being resolved. Then, in step 476, the BLE library 442 forwards the encrypted cloud challenge and the IoT challenge to the IoT device 366. In step 478, the IoT device 366 validates the encrypted cloud challenge and the encrypted IoT challenge. Then, in step 480, the IoT device transmits the encrypted IoT challenge to the BLE library 44, and in step 482, the BLE library 442 transmits the encrypted IoT challenge to the application 254 and an indication that OOB stage one has been resolved. In step 484, the application 254 forwards the encrypted IoT challenge and the MAC address to the cloud 256, whereupon the cloud validates the encrypted IoT challenge using a key. Then, in step 486, the cloud 256 grants the user 362 pad authorization per policy and transmits pad credentials to the application 254. At this point, the applications 254 is authorized to access the IoT pool pad via the IoT device 366, whereupon in step 488 the application 254 can issue control commands and other information to the IoT device 366.

FIG. 13 is a diagram illustrating steps carried out by the system of the present disclosure, indicated generally at 490, for upgrading firmware of an IoT device. In step 500, the application 254 obtains a token (e.g., and over-the-air (OTA) token) from an OTA token server 494. In response, in step 502, the OTA token server 494 transmits the OTA token and the address of the server 494 to the application 494. In step 504, the application 254 issues a query (“Get”) to an OTA server 492. In step 506, the server 492 response with an authorization (“OK”). Then, in step 508, the application 254 requests deployment of a firmware upgrade, and in response in step 510, the OTA server 492 responds with an authorization message. At this point, the firmware updating process begins.

In step 512, a firmware upgrade application 498 presents the user 362 (e.g., in a user interface displayed to the user on the smart phone 16, for example) with a firmware upgrade list. In step 514, the user 362 choses a file for the firmware upgrade. In step 516, the application 254 issues a request to retrieve the firmware file to a file storage server 496. In response, the file storage server 496 transmits the requested firmware file to the software application 254 in step 518, which then processes the firmware update (e.g., transmits the firmware update to the IoT device 366, which could be any of the devices 12 of FIG. 1). In step 520, the application issues a power-on startup test (POST) deployment feedback message to the OTA server 520, indicating whether the firmware file was successfully updated and is functioning properly after startup of the IoT device 366. In step 522, an acknowledgement is transmitted from the OTA server 492 to the application 254.

In the event that the user desires to cancel the firmware upgrade process, the application 254 transmits a cancellation request in step 524 to the OTA server 492. In step 526, the OTA server 492 transmits an acknowledgement to the application 254. Then, in step 528, the application 254 transmits cancellation feedback to the OTA server 492, which sends an acknowledgement to the application 254 in step 530. In step 532, the application 254 sets a time to poll the system for further firmware updates.

FIG. 14 is a diagram illustrating steps carried out by the system of the present disclosure indicated generally at 540, for controlling operation of an IoT-connected pool or spa pump/In step 544, the user 362 logs into the application 254. In step 546, the application 254 logs into an account on the cloud 256 associated with the user 362. In step 548, the cloud 256 transmits a login successful message to the application 254. In step 550, the IoT device claiming processes 280 of FIG. 8 (discussed above) are carried out in order to claim (connect) the IoT device 366 (such as the IoT module 30 of FIG. 2) and it associated variable speed pump 254. Once the IoT device 366 (and its pump 542) are claimed in accordance with the processing steps of FIG. 8, step 552 occurs, wherein the user issues an operation command (e.g., manually turn the pump on at 75% speed), which is transmitted in step 554 from the application 254 to the IoT device 366. In step 556, the IoT device 366 instructs the pump 542 to operate at 100% speed to initiate priming of the pump 542. In response, the pump 542 transmits a status message in step 558 to the IoT device 366 indicating that the pump is priming at 100% speed with no errors, and the IoT device 366 then transmits that message in step 560 to the application 254. The status message is then displayed to the user in step 562, e.g., in a user interface such as a user interface of the smart phone 16 of FIG. 1. In step 564, the IoT device 366 executes a priming timer of a pre-defined time period, and once it has expired, step 566 occurs, wherein the IoT device 366 transmits an instruction to the pump 542 to operate at 75% speed. In response, in step 568, the pump 542 transmits a status message to the IoT device 366 indicating that the pump 542 is operating at 75% speed with no errors, which message is relayed in step 570 to the application 570 by the IoT device 366 and displayed to the user in step 572.

FIG. 15 is a diagram illustrating steps carried out by the system of the present disclosure, indicated at 580, for upgrading firmware of the IoT module. In step 582, the smart phone 16 of FIG. 1 issues a firmware upgrade preparation message to the IoT module 30 of FIG. 2, which sends a message back in step 584 to the phone 16 indicating that the module 30 supports the ability to perform a firmware upgrade. In step 586, the phone 16 transmits a firmware upgrade ready message to the IoT module 30, which causes the IoT module 30 to erase a range of memory (e.g., flash memory) required to accommodate the size of the firmware upgrade. Then, in step 588, the IoT module 588 responds to the phone 16 with a “ready” message if the flash memory is erased and the module 30 is ready for the firmware upgrade; otherwise, the module 30 responds with a “not ready” message which requires the phone 16 to re-poll the module 30.

In step 590, the phone 16 transfers the firmware upgrade file first in step 590 with no response needed from the module 30, and then in step 592 in packets until a chunk of the image (a pre-defined portion of size n bytes has been transmitted to the module 30. Then, in step 594, the module 30 saves each packet to the memory at the given offset, and keeps track of the latest saved offset address. In step 596, the phone 16 transmits the last packet of n-byte chunk, and requests a response from the IoT module 30. In step 598, the module 30 responds with the next expected data offset address. In step 600, the phone 16 determines whether the address in the module's response matches the address expected by the phone 16, and checks if the device missed packets. In step 602, the phone resumes transmitting from the address in the module's response if it does not match the last sent address. Then, in step 604, the phone repeats transmissions and checks for response at n-byte chunks until the full image is complete. In step 606, the module 30 transmits a response to the phone 16 indicating that the last data packet of the firmware image has been saved, and in step 608, the phone 16 transmits a message to the module 30 indicating that the firmware update is complete. In step 610, the module 30 transmits an acknowledgement to the phone 16. In step 612, the module 30 resets to a bootloader, then in step 614 the bootloader copies the firmware from the memory (e.g., flash memory) to an internal memory of the module 30. Finally, in step 616, the module 30 verifies the integrity of the firmware update, and once verified, installs the firmware.

FIGS. 16A-16B are diagrams illustrating steps carried out by the system of the present disclosure, indicated generally at 620, for controlling an IoT-connected pool or spa pump and an IoT-connected heater. In step 628, the IoT-connected pump 624 and the IoT-connected heater 626 initialize communication with each other using the sub-gigahertz network, such as the network 14 of FIG. 1. In step 630, the application 254 logs into a user account on the cloud 256, which responds in step 632 with a login successful message. In step 634, the IoT device claiming processes 280 of FIG. 8 (discussed above) are carried out in order to claim (connect) the IoT-connected pump 624 and the IoT-connected heater 626. Once these devices are successfully claimed, step 636 occurs, wherein the IoT pump 624 initiates operation at 75% heat output. Next, in step 638, the pump 624 broadcasts a status message to the heater 626, instructing the pump 626 to operate in a filtration schedule at 100% speed to initiate priming of the pump. Next, in step 640, the pump 624 transmits a status message to the application 254 indicating that the pump is being operated in filtration schedule at 100% speed and that the heater 626 is off. The status message is then transmitted to the cloud 256 by the application 254.

FIG. 17 is a diagram 700 illustrating IoT connectivity in accordance with the present disclosure between the mobile phone 16, the IoT gateway device 18, and an IoT-connected device 12 such as an IoT-connected variable speed pump. In step 702, the phone 16 executes a software application which creates a JavaScript Object Notation (JSON) message that includes a command for the IoT-connected device 12 to execute (such as changing pump speeds, turning on/off, etc.). Then, in step 704, the JSON message is wrapped in a secure hypertext transfer protocol (HTTPS) message and sent to the cloud 256 via a mobile application programming interface (API) 705. It is noted that the cloud 256 could be a suitable cloud computing platform having IoT communications/support features, such as the Amazon AWS IoT core cloud computing platform or other suitable cloud computing platform. In step 706, the cloud 256 converts the JSON message into a universal binary JSON (UBJSON) message, encodes binary data into base64 data, and packages the data into an MQ Telemetry Transport (MQTT) message. In step 708, the MQTT message is published by the cloud 256 on a communications channel to which the gateway 18 is connected. In step 710, the gateway 18 receives the MQTT message, decodes it into base64 data, and then decodes the base64 data to a UBJSON message. In step 712, the UBJSON message is converted into a radio messaging protocol format by wrapping the UBJSON message in the radio message protocol and is then transmitted to a sub-gigahertz (e.g., 900 MHz) radio module 714 of the gateway 18. Next, in step 716, the module 714 wraps the data into one or more sub-gigahertz packets and send the packets over a sub-gigahertz network, such as the network 14 of FIG. 1. In step 718, the IoT module 30 reassembles the received subgighertz packets into a message, and in step 720, the IoT module 30 parses the message to determine one or more control commands to be issued to the IoT-connected device 12 (in a format compatible with the IoT-connected device). Finally, in step 722, the IoT module 30 transmits the one or more control commands to the IoT-connected device 12 over a communications link (such as an RS-485 serial data communications link), for execution by the IoT-connected device 12. For example, if the one or more control commands is a request to turn a pump on at 100% speed and the IoT-connected device 12 is a pump, the pump changes speed to 100% in response to receipt of the control command.

The IoT-connected device 12 can also communicate one or more status and/or performance parameters to the phone 16 using the IoT module 30, the gateway 18, and the cloud 256. For example, in step 724, the IoT module 30 converts (wraps) the status or performance parameter (such as an acknowledgement or “ACK” message in a format generated by the IoT-connected device, acknowledging that the device 12 successfully received a control command and is executing such command) into a sub-gigahertz packet format and sends the packet to the gateway 18 using the wireless network 14 of FIG. 1, which is received by the sub-gigahertz radio module 714 of the gateway 18. Next, in step 726, the gateway 18 receives the ACK message and wraps it into a UBJSON message. Then, in step 728, the gateway 18 encodes the UBJSON message into a base64 data, and then encodes the base64 data into an MQTT message. In step 730, the MQTT message is transmitted (published) on a communications channel to the cloud 256. In step 732, the cloud 256 receives the MQTT message and converts the UBJSON message into a JSON message. Then, in step 734, the JSON message is wrapped into an HTTPS message and sent by the mobile API 705 to the phone 16. Finally, in step 736, the phone receives the HTTPS message, upwraps it into the JSON message, and processes the JSON message (e.g., extracts and processes the ACK message originally sent by the IoT-enabled device 12, so that the phone 16 knows that the IoT-enabled device 12 successfully received and executed a control command (e.g., setting the pump speed to 100%) previously sent to it. Of course, the IoT-enabled device 12 can send a variety of other types of messages using the processing steps and components discussed herein (e.g., pump speeds, flow rates, voltages/currents, power consumption, operational state, priming state, error states, etc.)

FIG. 18 is a diagram illustrating IoT connectivity in accordance with the present disclosure between the phone 16 and the IoT-connected device 12, such as an IoT-connected pump. In step 752, the phone 16 executes a software application which creates a JSON message that includes a command for the IoT-connected device 12 to execute (such as changing pump speeds, turning on/off, etc.), and transmits the JSON message to a Bluetooth Low Energy (BLE) communications software library 753 executing on the phone 16. In step 754, the BLE communications library 753 encodes the JSON message into a UBJSON message. Then, in step 756, the library 753 converts the UBJSON packet into one or more BLE packets formatted for BLE transmission. Optionally, arrays may be optimized during this process. In step 758, the library 753 sends the BLE packets over a Bluetooth wireless connection to the IoT module 30 of the IoT-connected device 12. Next, in step 760, the module 30 reassembles a message from the received packets, and in step 762, extracts the command (originally issued by the phone 16) from the reassembled message and parses the command. Then, in step 764, the command is sent to the IoT-connected device 12 in a format compatible with the IoT-connected device 12 using a suitable data connection 766 (such as RS-485 serial data connection), which then executes the command. The command could be any type of control command such as, but not limited, to a request to operate the device 12 at a particular speed, e.g., operate a pump at 100% speed.

The IoT-connected device 12 can also communicate one or more status and/or performance parameters to the phone 16 over Bluetooth. For example, the device 12 may issue an acknowledgement or “ACK” message in a format generated by the device 12, acknowledging that the device 12 successfully received and executed a control command sent to it. In step 768, the module 30 sends the ACK message over the Bluetooth wireless connection to the phone 16 in the format of one or more BLE packets. Then, in step 770, the BLE library 753 converts the BLE packets back into UBJSON format, and in step 772, the library 753 decodes the UBJSON format into a JSON message. Finally, in step 774, the application executing on the phone 16 receives the JSON message, extracts the ACK message, and processes it, so that the phone 16 knows that the IoT-enabled devices 12 successfully received and executed the control command previously transmitted to it by the phone 16.

It is noted that the various components discussed herein could include additional functionality and/or features. For example, the IoT modules and gateway discussed herein, as well as the cloud platform with which such modules communicate, could determine if there are neighboring IoT-connected pool/spa devices within range of the IoT modules/gateway, and if so, radiofrequency (RF) channels could be automatically selected and configured to minimize interference with such neighboring devices. Additionally, RF “hopping” techniques could be implemented by the IoT modules/gateway disclosed herein, so as to automatically and/or periodically switch RF channels to alleviate/eliminate interference. Further, the BLE profiles discussed herein (utilized for purposes of “claiming” IoT-connectable pool/spa devices) could include manufacturer-specific information so as to distinguish one IoT-connectable device from another device, and/or to allow only devices of specific types and/or manufacturers to be connected. Still further, the BLE profiles could be uniquely numbered and grouped by function of the particular device.

The systems/methods disclosed herein could also grant privileges to temporary users such as servicers or other individuals, and/or grant privileges for a certain duration of time or for certain operations. Additionally, the system can authorize and pass credentials to other users without having to “re-claim” credentials. In such circumstances, users will not have to perform any Bluetooth-related operations such as pairing devices, bonding devices, etc. Still further, the system could configure parameters of a pool device in a network through any other configured devise by passing configuration information over the network, such as over the wireless sub-gigahertz network 14 of FIG. 1. For example, if a heater is added to a pool/spa installation that only has a pump, the pump can obtain information related to the newly-added heater using the network 14.

As can be appreciated, the systems and methods disclosed herein permit retrieval of telemetry from all devices on the network efficiently using point-to-point network connections. For example, a pool heater could demand that a connected pool pump turn on via the network without any designated master device being required. Additionally, connected pool/spa devices can operate as a system without requiring a central controlling node. Still further, the system can assign network configurations based on locations using the cloud to determine nearby networks in order to minimize RF interference of nearby networks. Wireless pool pad networks can be configured to avoid conflicts with outer nearby networks via a personal area network (PAN) identifier, and the cloud could optimize such identifiers.

The “claiming” process described herein allows a software application (e.g., executing on the phone 16 of FIG. 1) to show unclaimed devices for discovery and connection of such devices in the future. This allows a user such as an installer to easily go through a pool/spa equipment pad and claim all required/desired devices. Additionally, the firmware update process discussed herein could be provisioned through a second gateway device, and/or the firmware update process could operate in the background. The gateway device could download an image for the device to be updated on the sub-gigahertz network (e.g., the network 14 of FIG. 1) and then update the device in the background, without interfering with operation. Still further, a single radio multiplexing approach between two different protocols could be implemented for cost savings, and channel hopping on one or more of the wireless networks disclosed herein could be implemented with a sufficient dwell period to allow for reliable communications. Moreover, forward error correction techniques could be utilized with one or more of the wireless networks disclosed herein to improve connection/communication reliability, and a keeper-follower model could be implemented for channel hopping. Additionally, the system could negotiate one or more network “keepers” using MAC addresses, if desired.

FIG. 19 is a block diagram illustrating additional features of the IoT connectivity module 30 of the present disclosure, wherein high-voltage isolation is provided. Advantageously, high-voltage isolation protects electrical components of the module 30 from voltage spikes that could be generated from various components, such as the pool/spa devices 12 of FIG. 1 (e.g., spikes generated by a variable speed pump connected to the module 30). Isolation is provided by power supply isolation circuit 802 (which provides isolated voltages suitable for use by the module 30, such as isolated 10V and 3.3V power supply voltages) and communications isolation circuit 806, which are positioned between and in communication with connector 800 (which connects the module 30 to one of the pool/spa devices 12 of FIG. 1) and the radio module 808. As noted above, the module 30 could have various input/output components, such as one or more LEDs 810, a pushbutton switch 812, a JTAG communications interface 814, and/or a debugging connection 816. A real-time clock 818 provides clock signals to the module 808, and a sensor connection 820 and sensor conditioning circuitry 822 allow the module 808 to receive and process one or more sensor signals, such as from a water temperature sensor or other type of sensor.

FIGS. 20-21 are schematic diagrams illustrating the high-voltage isolation circuitry of FIG. 19 in greater detail. As can be seen in FIG. 20, isolation circuit 806 provides for communications isolation (illustrated by dashed line 838) between the connector 810 (which can be connected to one of the pool/spa devices 12 of FIG. 1) and circuitry of the module 30. Such isolation can be provided by optoisolators 834 and 836 and the associated support circuitry illustrated in FIG. 20, such that optoisolator 834 provides electrical isolation in connection with data transmitted from the module 30 to a pool/spa device 12, and optoisolator 836 provides electrical isolation in connection data received by the module 30 from the pool/spa device 12. The isolated transmit and receive circuit outputs are identified by connections 840, 842, and are connected to the remainder of the module 30 (e.g., to the radio module 808 of FIG. 19). As can be seen in FIG. 21, power supply isolation circuit 802 provides isolation (illustrated by dashed line 858) between the connector 800 of FIG. 19 (which can be connected to one of the pool/spa devices 12 of FIG. 1) and the circuitry of module 30. Such isolation can be supplied by isolation transformer 854, optoisolator 856, and associated pre-isolation and post-isolation support circuit components 852, 860 shown in FIG. 21.

Having thus described the system and method in detail, it is to be understood that the foregoing description is not intended to limit the spirit or scope thereof. It will be understood that the embodiments of the present disclosure described herein are merely exemplary and that a person skilled in the art may make any variations and modification without departing from the spirit and scope of the disclosure. All such variations and modifications, including those discussed above, are intended to be included within the scope of the disclosure. What is desired to be protected by Letters Patent is set forth in the following claims.

What is claimed is:

1. An Internet-of-Things connectivity module for a pool or spa device, comprising:
an input/output module configured for communication with a pool or spa device;
a radio module having a first wireless transceiver configured for wireless communication with a user wireless device and a second wireless transceiver configured for wireless communication with a gateway device, and
a processor in communication with and controlling the input/output module and the radio module,
wherein the radio module is configured to receive a control command formatted in a first format using at least one of the first wireless transceiver or the second wireless transceiver, the processor is configured to process the control command into a second format compatible with the pool or spa device, and the input/output module is configured to transmit the control command in the second format to the pool or spa device, the pool or spa device executing the control command to control operation of the pool or spa device.

2. The module of claim 1, wherein the first wireless transceiver comprises a Bluetooth Low Energy transceiver and the second wireless transceiver comprises a sub-gigahertz wireless network transceiver.

3. The module of claim 2, wherein the first format comprises at least one of a Bluetooth Low Energy packet format or a sub-gigahertz wireless packet format.

4. The module of claim 3, wherein the second format comprises a pool or spa device control command format.

5. The module of claim 1, wherein the input/output module is configured to receive a status message from the pool or spa device formatted in a third format, the processor is configured to process the status message into a fourth format, and the radio module is configured to transmit the status message to the user device in the fourth format using at least one of the first wireless transceiver or the second wireless transceiver.

6. The module of claim 5, wherein the first wireless transceiver comprises a Bluetooth Low Energy transceiver and the second wireless transceiver comprises a sub-gigahertz wireless network transceiver.

7. The module of claim 6, wherein the third format comprises a pool or spa device status message format.

8. The module of claim 7, wherein the fourth format comprises at least one of a Bluetooth Low Energy packet format or a sub-gigahertz wireless packet format.

9. The module of claim 1, wherein the module is positionable within the pool or spa device.

10. The module of claim 1, wherein the gateway device is in communication with a cloud platform over the Internet.

11. The module of claim 10, wherein the cloud platform communicates with the gateway device and the IoT module and registers the pool or spa device as an IoT-connected pool or spa device.

12. The module of claim 10, wherein the cloud platform maintains and updates a database of IoT-connected pool or spa devices present at a pool or spa equipment pad.

13. The module of claim 1, wherein the processor is configured to receive and install firmware updates transmitted to the radio module over the first wireless transceiver.

14. The module of claim 1, wherein isolated power or isolated data is supplied to the radio module by one or more isolation circuits in communication with the radio module.

15. A method for providing Internet-of-Things connectivity for a pool or spa device, comprising:
receiving a control command formatted in a first format at an input/output module in communication with a pool or spa device using at least one of: (i) a first wireless transceiver of a radio module configured for wireless communication with a user device or (ii) a second wireless transceiver of the radio module configured for wireless communication with a gateway device;
processing by a processor of the input/output module the control command into a second format compatible with the pool or spa device; and
transmitting the control command in the second format to the pool or spa device from the input/output module to the pool or spa device, the pool or spa device executing the control command to control operation of the pool or spa device.

16. The method of claim 15, wherein the first wireless transceiver comprises a Bluetooth Low Energy transceiver and the second wireless transceiver comprises a sub-gigahertz wireless network transceiver.

17. The method of claim 16, wherein the first format comprises at least one of a Bluetooth Low Energy packet format or a sub-gigahertz wireless packet format.

18. The method of claim 17, wherein the second format comprises a pool or spa device control command format.

19. The method of claim 15, further comprising receiving at the input/output module a status message from the pool or spa device formatted in a third format, processing by the processor of the input/output module the status message into a fourth format, transmit by the radio module the status message to the user device in the fourth format using at least one of the first wireless transceiver or the second wireless transceiver.

20. The method of claim 19, wherein the first wireless transceiver comprises a Bluetooth Low Energy transceiver and the second wireless transceiver comprises a sub-gigahertz wireless network transceiver.

21. The method of claim 20, wherein the third format comprises a pool or spa device status message format.

22. The method of claim 21, wherein the fourth format comprises at least one of a Bluetooth Low Energy packet format or a sub-gigahertz wireless packet format.

23. The method of claim 15, wherein the gateway device is in communication with a cloud platform over the Internet.

24. The method of claim 23, further comprising communicating by the cloud platform with the gateway device and the IoT module, and registering the pool or spa device as an IoT-connected pool or spa device.

25. The method of claim 24, further comprising maintaining and updating a database of IoT-connected pool or spa devices present at a pool or spa equipment pad.

26. The method of claim 15, further comprising receiving and installing by the processor firmware updates transmitted to the radio module over the first wireless transceiver.

27. The method of claim 15, further comprising supplying isolated power or isolated data to the radio module by one or more isolation circuits in communication with the radio module.
